(19) United States
(12) Patent Application Publication
(10) Pub. No.: US 2025/0098732 A1
(43) Pub. Date: Mar. 27, 2025

(54) MACHINERY FOR FORMING SMOKING ARTICLES OF CANNABIS COMPOSITIONS

(71) Applicant: HEXO OPERATIONS INC., Gatineau (CA)

(72) Inventors: Kerry HIERONS, Gatineau (CA); Michael MARTIN, Gatineau (CA); Simon SIMMONS, Gatineau (CA)

(73) Assignee: HEXO OPERATIONS INC., Gatineau, QC (CA)

(21) Appl. No.: 18/709,126

(22) PCT Filed: Nov. 9, 2022
(86) PCT No.: PCT/CA2022/051655

§ 371 Date: May 10, 2024

Related U.S. Application Data
(60) Provisional application No. 63/278,930, filed on Nov. 12, 2021.

(51) Int. Cl. A24C 5/18; A24D 1/18; F16N 15/00

(52) U.S. Cl. CPC A24C 5/1864; A24C 5/1807; A24C 5/1871; A24C 5/1892; F16N 15/00; A24D 1/18; F16N 2210/24

(57) ABSTRACT

Various embodiments herein relate to machinery for forming smoking articles of cannabis compositions. In at least one embodiment, there is provided a system for alcohol-based lubrication for pre-roll machinery comprising: a reservoir tank for retaining lubricant fluid; a tube conduit having a first end fluidically coupled to the reservoir tank and an open second end; and a modified pre-roll member having a fluid-receiving opening coupled to the second tube end, the modified pre-roll member further comprising a bottom contact surface including one or more fluid exit openings coupled to the fluid-receiving opening.

### CROSS-REFERENCE TO PREVIOUS APPLICATION

This application claims priority from U.S. provisional patent application No. 63/278,930 filed on Nov. 12, 2021, which is incorporated herein by reference in its entirety.

### TECHNICAL FIELD

Various embodiments are described herein that relate to machinery for cannabis compositions, and in particular, to machinery for forming smoking articles of cannabis compositions.

### BACKGROUND

The following is not an admission that anything discussed below is part of the prior art or part of the common general knowledge of a person skilled in the art.

Upon stage-wise legalization of cannabis-based consumer products in Canada and eventually in various other areas in the world, industrial scale production and accessibility to a wide variety of forms have accelerated in order to fill emerging demands.

Although there are different methods of consuming cannabis-based consumer products (e.g., oral ingestion, topical administration or vaping cannabis oil), smoking is still the preferred mode of consuming cannabis. Typically, to form cannabis smoking articles, such as but not limited to pre-rolled joints (also referred to herein as pre-rolls), cannabis material is reduced to a particulate form and loaded into a rolling medium (typically a rolling tube, cone, or wrapper). The cannabis joints can then be lit and resulting smoke is inhaled by the user.

Traditional machinery designed for forming tobacco cigarettes offers a logical starting point for designing machinery for forming cannabis smoking articles. However, cannabis and tobacco have many different physical characteristics that complicate how cannabis smoking articles can be formed. For example, cannabis is typically stickier than tobacco and has a tendency to stick to machinery during manufacturing processes.

Accordingly, there is a need for new and improved devices and methods of forming cannabis smoking articles.

### SUMMARY OF THE VARIOUS EMBODIMENTS

The following introduction is provided to introduce the reader to the more detailed discussion to follow. The introduction is not intended to limit to define any claim or as yet unclaimed invention. One or more inventions may reside in any combi nation or sub-combination of elements or process steps disclosed in any part of this document including its claims and figures.

In accordance with a broad aspect of the teachings herein, there is provided a system for alcohol-based lubrication for pre-roll machinery comprising: a reservoir tank for retaining lubricant fluid; a tube conduit having a first end fluidically coupled to the reservoir tank and an open second end; and a modified pre-roll member having a fluid-receiving opening coupled to the second tube end, the modified pre-roll member further comprising a bottom contact surface including one or more fluid exit openings coupled to the fluid-receiving opening.

In some embodiments, the modified pre-roll member comprises one or more of a modified tongue member and a modified shoe member.

In some embodiments, the bottom contact surface, of the modified pre-roll member, has an upstream end and a downstream end, the downstream end being opposed to the upstream end.

In some embodiments, the one or more fluid exit openings are positioned proximal the upstream end.

In some embodiments, the one or more fluid exit openings are positioned proximal the downstream end.

In some embodiments, the one or more fluid exit openings are positioned proximal each of the upstream and the downstream ends.

In some embodiments, the one or more fluid exit openings are positioned between the upstream end and the downstream end.

In some embodiments, the one or more fluid exit openings are distributed between the upstream end and the downstream end, and the distribution is either uniform or non-uniform.

In some embodiments, a valve is positioned along the tube conduit, and is controllable to adjust the drip rate of the lubricant fluid through the modified pre-roll member.

In some embodiments, the drip is adjusted having regarding to one or more drip rate adjusting factors.

In some embodiments, the one or more drip rate adjusting factors comprise one or more of a dryness of the cannabis composition, and a rod manufacturing rate.

In some embodiments, the system further comprises a controller coupled to a valve control mechanism, the valve control mechanism being operable to the control valve to automatically adjust the drip rate, and the controller is operable to transmit control instructions to the valve control mechanism based on the one or more drip rate adjusting factors.

In some embodiments, the system further comprises one or more sensors coupled to the controller, the sensors operable to monitor one or more cannabis composition properties, and the controller is operable to determine the one or more drip rate adjusting factors based on the one or more monitored cannabis composition properties.

In some embodiments, the lubricant fluid is an alcohol-based compound.

In some embodiments, the alcohol-based compound comprises 99% ethanol fluid.

In another broad aspect, there is provided a system for forming a cannabis smoking article, the system comprising: a conveyance system configured to convey a cannabis composition from a repository and deposit the cannabis composition on a rolling medium; one or more rotatable disks configured to control a dispersion of the cannabis composition on the rolling medium; one or more rolling members configured to roll the rolling medium around the cannabis composition and form the smoking article, the one or more rolling members including a modified pre-roll member comprising a fluid receiving opening for receiving a lubricant from a reservoir tank and one or more liquid exit openings fluidly coupled to the fluid-receiving opening and configured to deliver the lubricant to the cannabis composition.

In another broad aspect, there is provided a system for forming a cannabis smoking article, the system comprising: a conveyance system configured to convey a cannabis composition from a repository and deposit the cannabis composition on a rolling medium; one or more modified rotatable disks configured to control a dispersion of the cannabis composition on the rolling medium; a reservoir tank for retaining lubricant fluid; and a tube conduit having a first end fluidically coupled to the reservoir tank and an open second end coupled to the modified rotatable disk.

In another broad aspect, there is provided a method for alcohol-based lubrication for pre-roll machinery comprising: determining a drip rate based on one or more drip rate adjusting factors; adjusting a valve mechanism to apply the drip rate; applying the alcohol-based lubrication via a modified pre-roll member, wherein the modified pre-roll member has a fluid-receiving opening coupled to a second tube end of a tube conduit, the modified pre-roll member further comprising a bottom contact surface including one or more fluid exit openings coupled to the fluid-receiving opening and used for extruding the alcohol-based lubricant, wherein the tube conduit has a first end fluidically coupled to a reservoir tank for retaining the lubricant fluid, and the valve is positioned along the tube conduit, and is controllable to adjust the drip rate of the lubricant fluid through the modified pre-roll member.

In some embodiments, the modified pre-roll member comprises one or more of a modified tongue member and a modified shoe member.

In some embodiments the one or more drip rate adjusting factors comprise one or more of a dryness of a cannabis composition, and a rod manufacturing rate.

Other features and advantages of the present application will become apparent from the following detailed description taken together with the accompanying drawings. It should be understood, however, that the detailed description of the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

A detailed description of specific exemplary embodiments is provided herein below with reference to the accompanying drawings in which:

FIG. 1 is a process flow for an example embodiment of manufacturing a cannabis smoking article in accordance with embodiments provided herein;

FIGS. 2A-2B are non-limiting examples of smoking article representations in accordance with an embodiments provided herein;

FIG. 3 is a schematic illustration of a portion of a cannabis pre-rolling machine, in accordance with some embodiments;

FIG. 4A is an example embodiment of a tongue member;

FIG. 4B is an example embodiment of a shoe member;

FIG. 5A is a schematic illustration of a portion of a cannabis pre-rolling machine, in accordance with some other embodiments;

FIG. 5B is a schematic illustration of a portion of a cannabis pre-rolling machine, in accordance with still some other embodiments;

FIG. 5C is a schematic illustration of a portion of a cannabis pre-rolling machine, in accordance with still yet some other embodiments;

FIG. 5D is a schematic illustration of a portion of a cannabis pre-rolling machine, in accordance with other embodiments;

FIG. 5E is a schematic illustration of a portion of a cannabis pre-rolling machine, in accordance with some embodiments;

FIG. 5F is a schematic illustration of a portion of a cannabis pre-rolling machine, in accordance with some other embodiments;

FIG. 6A is an example embodiment of a modified tongue member, in accordance with some embodiments;

FIG. 6B is a cross-sectional view of the modified tongue mechanism of FIG. 6A, taken along the cross-sectional line 6B-6B′ of FIG. 6A;

FIGS. 6C-6F are various cross-sectional views of the modified tongue member of FIG. 6A, taken along the cross-sectional line 6A-6A′, in accordance with other embodiments;

FIG. 7A is a bottom up perspective view of a modified shoe member;

FIG. 7B-7H are various cross-sectional views of the modified shoe member of FIG. 7A, taken along the cross-sectional line 7-7′ of FIG. 7A, in accordance with other embodiments; and

FIG. 8 is a simplified block diagram of an example embodiment of a drip rate control system.

In the drawings, exemplary embodiments are illustrated by way of example. It is to be expressly understood that the description and drawings are only for the purpose of illustrating certain embodiments and are an aid for understanding. They are not intended to be a definition of the limits of the invention.

### DESCRIPTION OF VARIOUS EMBODIMENTS

A detailed description of one or more embodiments of the invention is provided below along with accompanying figures that illustrate the principles of the invention. The invention is described in connection with such embodiments, but the invention is not limited to any embodiment. The scope of the invention is limited only by the claims. Numerous specific details are set forth in the following description to provide a thorough understanding of the invention. These details are provided for the purpose of non-limiting examples and the invention may be practiced according to the claims without some or all of these specific details. Technical material that is known in the technical fields related to the invention has not been described in detail so that the invention is not unnecessarily obscured.

### I. Cannabis Composition

As used herein, the term “Cannabis” generally refers to a genus of flowering plants that includes a number of species. There are three different species that have been recognized, namely Cannabis sativa, Cannabis indica and Cannabis ruderalis. Hemp, or industrial hemp, is a strain of the Cannabis sativa plant species that is grown specifically for the industrial uses of its derived products. Hemp has lower concentrations of the cannabinoid tetrahydrocannabinol (THC) and higher concentrations of the cannabinoid cannabidiol

(CBD), which decreases or eliminates its psychoactive effects.

As used herein, the term “cannabis plant(s)”, encompasses wild type Cannabis and also variants thereof, including cannabis chemovars (or “strains”) that naturally contain different amounts of the individual cannabinoids. For example, some Cannabis strains have been bred to produce minimal levels of THC, the principal psychoactive constituent responsible for the high associated with it and other strains have been selectively bred to produce high levels of THC and other psychoactive cannabinoids. Cannabis plants produce a unique family of terpeno-phenolic compounds called cannabinoids, some of which produce the “high” one experiences from consuming marijuana.

As used herein, the term “cannabis plant material” refers to any part of the plant such as cannabis trim, cannabis flower (also called “cannabis bud”), cannabis kief, or any combination thereof. The plant material can be processed by removing any plant stems. The resulting cannabis material with stems removed can include both flower and trim, only cannabis trim or only cannabis flowers.

As used herein, the term “cannabis kief” refers to isolated cannabis trichomes, namely trichomes that have been separated from cannabis plant material plant using any method known in the art. For example, and without wishing to be limiting in any manner, the isolated cannabis trichomes may be obtained by a chemical separation method or may be separated by manual processes like dry sifting or by water extraction methods. Such methods are known in the art, and as such will not be further described here. Because of inherent limitations to existing separation methods, some plant matter or other foreign matter can be present in cannabis kief.

As used herein, the term “cannabis trim” generally refers to excess leaves a cultivator trims from the plants. For example, there are two types of leaves that are trimmed from cannabis buds; sugar leaves, which are smaller one-fingered leaves close to the bud, and fan leaves, which are larger multi-fingered leaves. Trimming of the cannabis can occur either before or after harvest of the plants. If done before, the trimming process maximizes the cannabis plant's bloom, yielding more desirable crystals. That is, a good trim will get the grower a bigger, higher quality plant yield. If trimming is carried out post-harvest, the appearance and odor of the buds are improved, and the lower leaf quantity makes the resulting plant matter “smoother” to smoke or vaporize. Because of inherent limitations to existing separation methods, some plant matter or other foreign matter can be present in cannabis trim.

Typically, cannabis plant material composition in particle form can be obtained by processing cannabis plant material of a certain size to reduce into pieces that are smaller than the original size. For example, such processing may include a pulverization process, such as comminution, crushing, or grinding, which apply an external force to reduce particles from an initial size to a smaller size. Examples of such external forces may include but is not limited to compression (e.g., where at least two working surfaces approach each other slowly, pressurizing the plant material uniformly, and crush same), impact (e.g., where a high-speed impactor such as a hammer or a ball impacts the plant material, or plant material collides with itself at high speed to cause crushing), shear (e.g., where plant material is cut into small pieces by a wedge, such as a cutter), and friction (e.g., where plant material is caught between two or more working surfaces that move relative to each other, and the movement of the working surfaces produces friction between the plant material and the working surfaces, and small pieces are scraped off from the plant material surface one after another). In some implementations, by applying compressive force and shear force to particles frictionally, fine powder is gradually produced from the particle surface, which can be suitable for ultra-fine pulverization.

### II. Manufacturing of Cannabis Smoking Article

Compositions of cannabis may be loaded into a rolling medium or wrapper to form a smoking article, for example a cannabis joint in the form of tube or cone. For example, the rolling medium or wrapper may be a pre-roll tube or cone (which requires loading the composition through an opening at one thereof) or may be a rolling tube or cone which requires rolling the material to enclose the composition. Cones mimic a funnel, with a larger opening for packing and a smaller opening for inhaling, allowing for a different type of air flow than a tube. A tube, on the other hand, has substantially the same diameter on the opening as it does on the mouthpiece, which mimics the joint type of air flow. It will be apparent that such loading may be performed at the manufacturing site or by an end-user. The rolling medium or wrapper may be any suitable rolling medium or wrapper known in the art. The rolling medium or wrapper can be made with a material such as paper, hemp, Cordia palm leaf, tendu leaf, flower petal, banana leaves, flax, sisal, rice straw, esparto, and the like, and may be transparent, colored and/or flavored. When desired, the rolling medium or wrapper may also further include an additive on one of its surfaces (internal or external), such as kief, terpenes, cannabis distillate, and the like.

As used herein, “rolling paper” may refer to sheets of thin paper that are used to encase cannabis. Rolling paper may comprise, by way of non-limiting examples, sheets of hemp, rice straw, wood pulp, or flax.

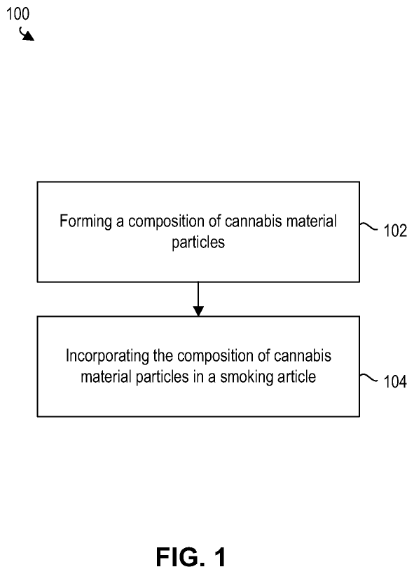

Reference is now made to FIG. 1, which shows a non-limiting flowchart of a process 100 of making smoking articles such as those described in accordance with various embodiments of the present disclosure.

The process 100 includes a step 102 of providing a composition of cannabis materials in particle form. The cannabis material composition has a polymodal particle size distribution that includes various particle size lots. Further, the composition can have pre-determined proportions of lots of particles at least based on a desired property of the composition (e.g., porosity, packaging density, etc.).

Once the composition has been provided, the composition can proceed to subsequent steps required for commercialization; for example, the composition can be packaged in ready-to-use single packages or can be packaged in multiple-use packages for the user to load into any desired smoking article.

Alternatively, or in addition, once the desired composition has been provided, at step 104 the composition is incorporated into a smoking article. For example, the composition can be loaded into a rolling medium or wrapper to form a cannabis cigarette or can be loaded into a mounting component of a heat-not-burn smoking device (either by the manufacturer or by the user), such as a cartridge or tube.

In various cases, when making a cannabis joint, the method step 104 entails loading a rolling medium or wrapper (such as a rolling paper, tube or cone, for example a pre-roll tube or cone) with the composition provided in step 102. The filling step can be done manually or done semi-automatically or automatically with rolling media or wrappers sequentially filled via a commercial joint filling apparatus. The rolling medium or wrapper loaded with the cannabis material composition can be closed at one end thereof (or at both ends thereof, in some implementations) to immobilize the composition into the rolling medium, thereby forming a cannabis joint. In some embodiments, the rolling medium or wrapper may be filled with a mixture including the cannabis material composition as well as other components, such as tobacco leaves or other additives (e.g., burning additives, smokable density additives, cannabis distillate, terpenes, flavonoids, etc., as discussed previously in this text). When making a mounting component of a heat-not-burn smoking device, the method step 104 entails loading the mounting component with the composition provided in step 102.

In at least some cases, step 104 may include loading a weight of the cannabis material composition selected in the range of from about 0.1 g to about 2.5 g (including any value therein, such as about 0.2 g, 0.5 g, 0.6 g, 1.0 g, 1.2 g, 1.5 g, 1.8 g, etc.). In some embodiments, the smoking article formed by the process 100 comprises from 0.5 g to 1.0 g of the cannabis material, such as 0.6 g.

### III. Features of Cannabis Smoking Articles

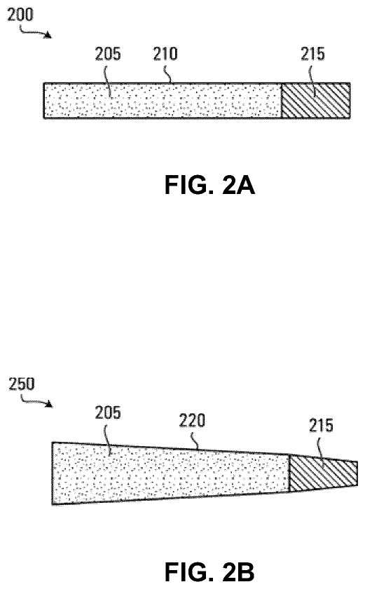

FIGS. 2A and 2B are non-limiting examples of smoking articles in accordance with different embodiments of this disclosure.

FIG. 2A shows smoking article 200 that is in the shape of a tube. As shown, the cannabis material composition 205 is in the interior of the smoking article 200, having been produced by process 100 as described with respect to FIG. 1. The smoking article 200 includes a wrapper 210 forming a tube. In some embodiments, the smoking article may further comprise a filter 215. The filter 215 may be used to enhance smoking experience by blocking cannabis residues or solid particles that may be produced upon burning of the cannabis material composition while smoking the smoking article.

FIG. 2B shows a smoking article 250 that is generally in the shape of a cone. As shown, the cannabis material composition 205 is in the interior of the smoking article 250, having been produced by process 100 as described with respect to FIG. 1. The smoking article 250 includes a wrapper 220 forming a cone. In some embodiments, the smoking article may also further comprise filter 215.

In some embodiments, the filter 215 can be a paper filter such as a spiral tip paper filter that gives a more even draw than a standard folded or “W” style filter. Alternatively, the filter 215 can be a wood or glass tips, which can change the look, feel and “smoke” of a joint. Glass tends to stay cool to the touch and gives a sturdy feel to the crutch. Wood also does not transfer heat as much, so it remains cool. Standard, spiral, glass, or wood tips can be put into a cone- or tube-shaped pre-roll.

The rolling medium or wrapper 210, 220 may form a smoking article having a length of from about 50 mm to about 300 mm (including any value therein, such as about 55 mm, 60 mm, 65 mm, 70 mm, 75 mm, 80 mm, 85 mm, 90 mm, 95 mm, 100 mm, 105 mm, 110 mm, 115 mm, 120 mm, etc.). The wrapper 210, 220 can be made with a material selected from paper, hemp, Cordia palm leaf, tendu leaf, flower petal, banana leaves, flax, sisal, rice straw, esparto, and the like, and may be transparent, colored and/or flavored. The rolling medium or wrapper 210, 220 may also further include non-toxic colorants, artwork, and/or a non-toxic additive on one of its surfaces (internal or external), such as kief, terpenes, cannabis distillate, and the like.

The geometry of the smoking article 200, 250 can be adjusted to account for the amount of cannabis material composition loaded therein. In some embodiments, the smoking article 200, 250 has a length from about 40 mm to about 300 mm, or from about 50 mm to about 140 mm, or from about 60 mm to about 130 mm, or from about 70 mm to about 120 mm, or from about 80 mm to about 110 mm. In tubular embodiments, the smoking article 200 has a substantially constant cross-sectional area across its length; for example, the cross-sectional area can correspond to a diameter of from 15 mm to 30 mm. The conic smoking article 250 has a variable cross-sectional area across its tapered length with a diameter of, for example, from about 30 to 20 mm on one end and a diameter of, for example, from about 15 to 10 mm on the opposite end.

In some embodiments, forming the smoking article 200, 250 includes densifying the cannabis composition particles in the smoking article. Densification can be achieved by applying pressure (called packing pressure) on the cannabis material composition that is loaded into the rolling medium or wrapper 210, 220, for example. In some embodiments, the pressure is applied on the cannabis material composition once the cannabis material composition entirely fills the rolling medium or wrapper 210, 220. In other embodiments, only a fraction of the rolling medium or wrapper 210, 220 is filled with a portion of the cannabis material composition and the pressure is subsequently applied to densify the portion, and the procedure repeated until the desired length of the rolling medium or wrapper 210, 220 is filled with the cannabis material composition. The packing pressure could be from about 40 psi to about 120 psi, or from about 50 psi to about 110 psi, or from 60 psi to about 100 psi, or from about 70 psi to about 90 psi, or about 85 psi, for example.

As a result of this densification process, different packing densities in the smoking article 200, 250 can be achieved. For example, a packing density in a range of from 100 to 400 mg/cm₃ is possible, or from about 200 to 300 mg/cm₃, or around 250 mg/cm₃.

### IV. Overview of Cannabis Pre-Rolling Machine Operation

As stated above with reference to FIG. 1, in the process of manufacturing cannabis smoking articles, the second processing stage (104 in FIG. 1) may entail incorporating the cannabis product into a rolling medium.

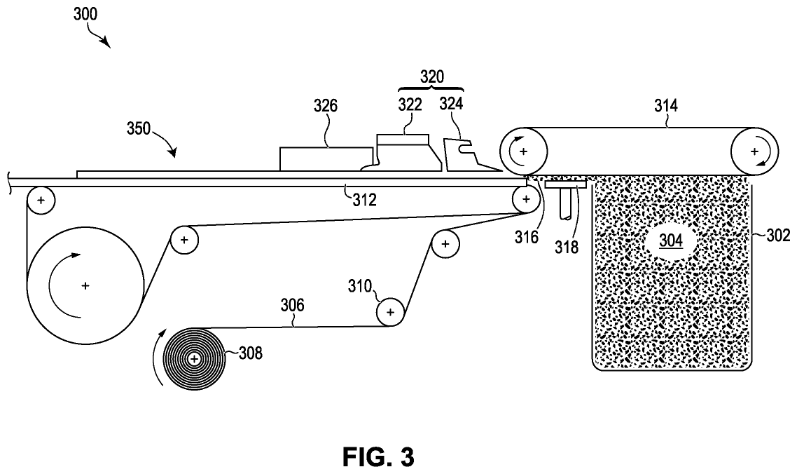

Reference is now made to FIG. 3, which shows a schematic illustration of a portion of a cannabis pre-rolling machine 300, in accordance with more conventional designs.

As shown, the pre-rolling machine 300 may include a repository structure 302 that stores a composition of particle cannabis 304. The repository structure 302 may comprise, for example, a bin, a basket or a hopper structure.

The pre-rolling machine 300 also includes the rolling medium 306, which is used to encapsulate the cannabis composition 304. In at least one embodiment, a bobbin structure 308 is used to retain the rolling medium 306, and a pulley system 310 is further used to unwind the rolling medium 306 therefrom. Pulley system 310 may deliver the flattened rolling medium 306 to a staging area 350 that includes a conveyor belt 312.

A conveyance system 314 may also convey the cannabis composition from the repository structure 302, and may deposit or disperse the cannabis composition 304 over the rolling medium 306 located on the conveyor belt 312. In some embodiments, as illustrated, the conveyance system 314 may comprise a separate conveyor belt. In other embodiments (not shown), the conveyance system 314 can comprise, for instance, a system of “scoopers” (i.e., scooping trays) for scooping the cannabis product from the repository 302 and depositing it on top of the rolling medium 306. Various other designs for conveyance systems 314 will occur to those skilled in the art.

In the illustrated embodiment, one or more rotatable disks 318 are positioned ahead of the staging area 350. The rotatable disks 318 may be controlled to adjust the rate of dispersion of the cannabis composition 304 over the rolling medium 306. In this manner, the fill and weight of the smoking article products may be controlled.

Once the cannabis product 304 is dispersed over the rolling medium 306, pre-rolling members 320 are used to roll the rolling medium 306 around the cannabis product such as to encapsulate the composition within the rolling medium 306 and to form a smoking article (i.e., FIG. 2A or 2B). Pre-rolling members 320 also serve to compress or constrict the loose cannabis particle composition such as to produce a compact composition that is more securely retained within the rolled medium.

Pre-roll members 320 can generally include one or more of a tongue member 322 and a shoe member 324. In cases where a shoe member 324 is provided, the shoe member 324 may be located upstream of the tongue member 322. As used herein, upstream and downstream are defined with reference to the direction of motion of the conveyor belt 312, or otherwise, the general direction of motion of the cannabis product through the pre-roll machine 300.

A pre-rolled cannabis article exits the pre-roll members 320 and an adhesive applicator 326 may be positioned downstream to apply adhesive to an exposed length of the rolling medium 306 such as to secure the rolling medium 306 around the cannabis product 304. The continuous length of rolled medium 306 may then be cut or subdivided into one or more smoking articles as desired.

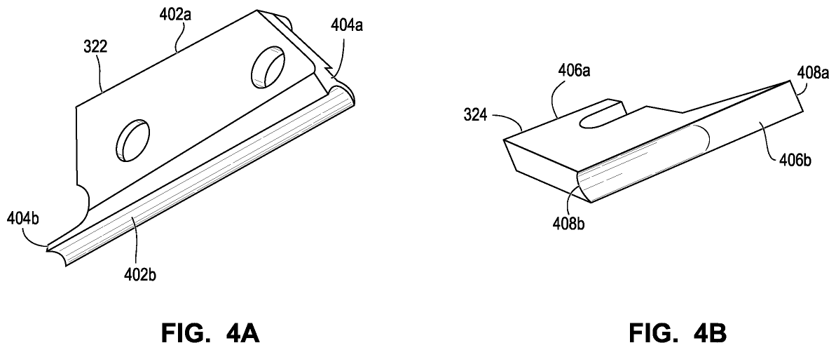

Reference is now made to FIGS. 4A and 4B, which show schematic illustrations of example embodiments of a tongue member 322 (FIG. 4A) and a shoe member 324 (FIG. 4B).

As shown in FIG. 4A, the tongue member 322 may include a top surface 402a and an opposed bottom surface 402b. In the upright position, the bottom surface 402b may face towards the conveyor belt 312 (or rolling medium 306), while the top surface 402a may face away from the belt 312.

In various cases, the bottom surface 402b may also define a contact surface which contacts the rolling paper 306 and cannabis product 304 as they travel under the tongue member 322. In the illustrated embodiment, contact surface 402b extends between an upstream end 404a and downstream end 404b, and may have a generally concave shape that narrows in circular cross-section towards the downstream end 404b. As the rolling medium 306 (i.e., carrying the dispersed cannabis 304) travels under the tongue member 322—the combination of the narrowing concave contact surface 402b and the conveyor belt 316 causes compaction of the cannabis product (i.e., via constriction of the narrowing passage). The narrowing passage also causes the rolling paper to gradually wrap around the compacted cannabis product. In this manner, a partially rolled cannabis article may exit from the downstream end 404b.

As shown in FIG. 4B, the shoe member 324 may have a generally similar design and may also include a top surface 406a and an opposed bottom surface 406b, whereby in an upright position, the bottom surface 406b may face towards the conveyor belt 312, while the top surface 406a may face away from the belt 312. The bottom surface 406b may also define a contact surface that extends between a respective upstream end 408a and downstream end 408b. The shoe contact surface 406b may transition from a sharp linear profile at the upstream end 408a, and may graduate to a profile concave downstream end 408b. The concave surface, of the downstream end 408b, can begin pre-rolling the rolling medium 406 around the cannabis product 304 in preparation for further forming by the tongue member 322

To this end, the inventors have appreciated that efficiently passing cannabis product through the pre-roll members 320 is a significant bottleneck in the mass production of paper rolled cannabis. As cannabis is often dense and “sticky” and may include many waxes and oils depending on the strain-loose cannabis encounters difficulty travelling through, for example, the narrowed passages of the tongue and/or shoe members described herein. In particular, the dense and “sticky” nature of the cannabis can often “clog” the pre-roll members at the narrowed passages. This, in turn, necessitates frequent stopping of the automated pre-rolling machine to clear out the clogged pre-roll members. The issue of clogging has presented a serious problem in the scaling of automated cannabis product manufacturing to accommodate high manufacturing rates.

V. Modified Pre-Roll Machine with Lubricant Application System

To at least partially mitigate the aforementioned problem, the inventors have further appreciated a benefit of applying lubricant to the loose cannabis composition, either before or during the stage in which the cannabis passes through the pre-roll members 320. More particularly, the lubricant may mix with the loose cannabis to reduce the friction between the loose cannabis and the contact surfaces of one or more of the pre-roll members 320. This, in turn, may reduce incidences of clogging as the cannabis products travel through the pre-roll members 320.

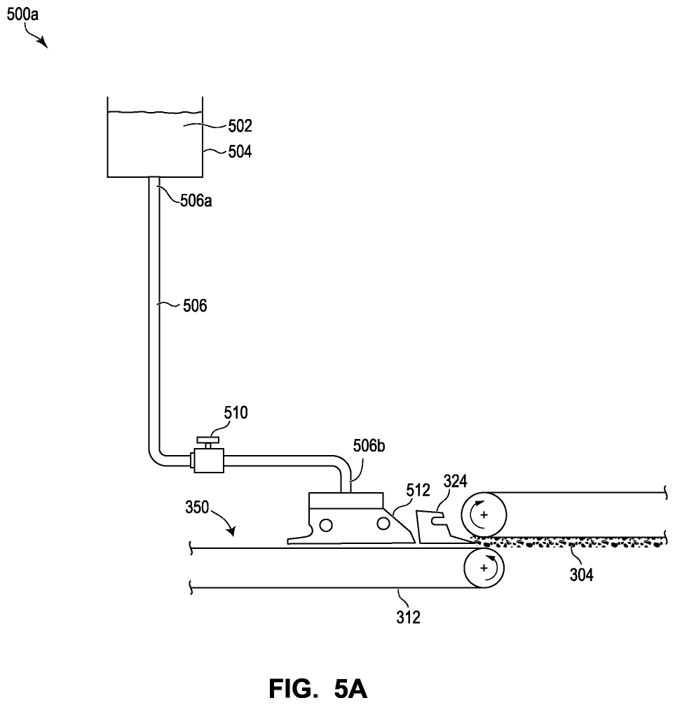

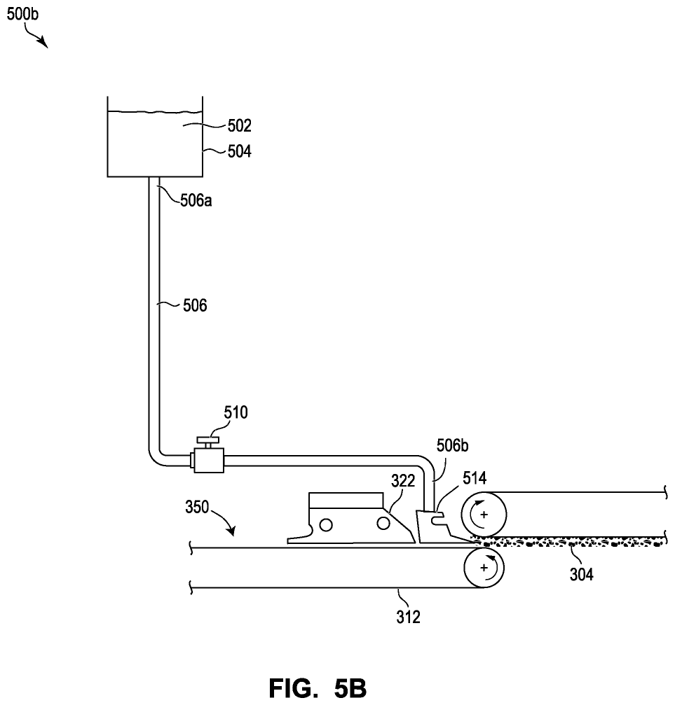

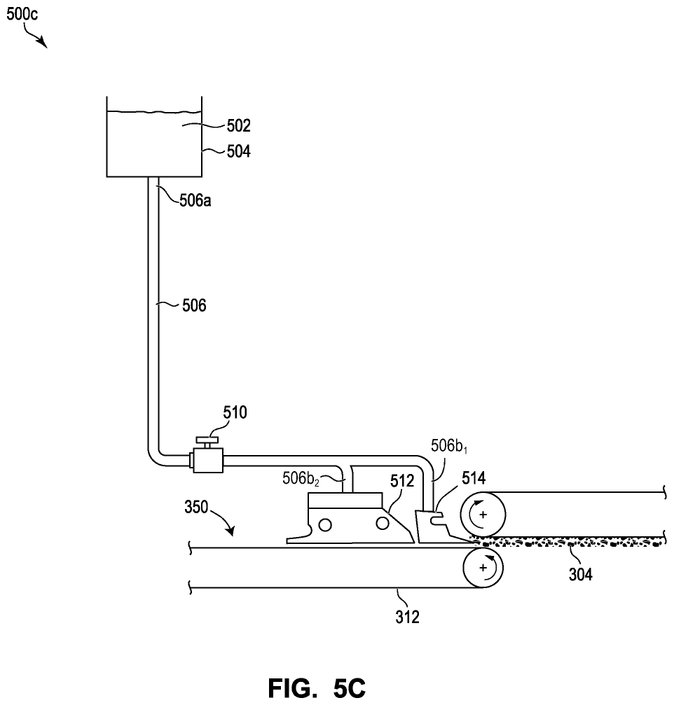

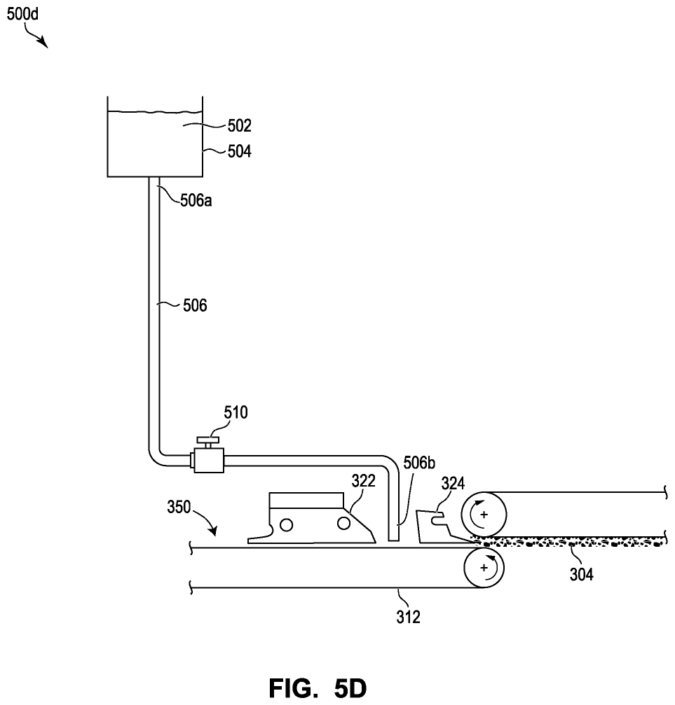

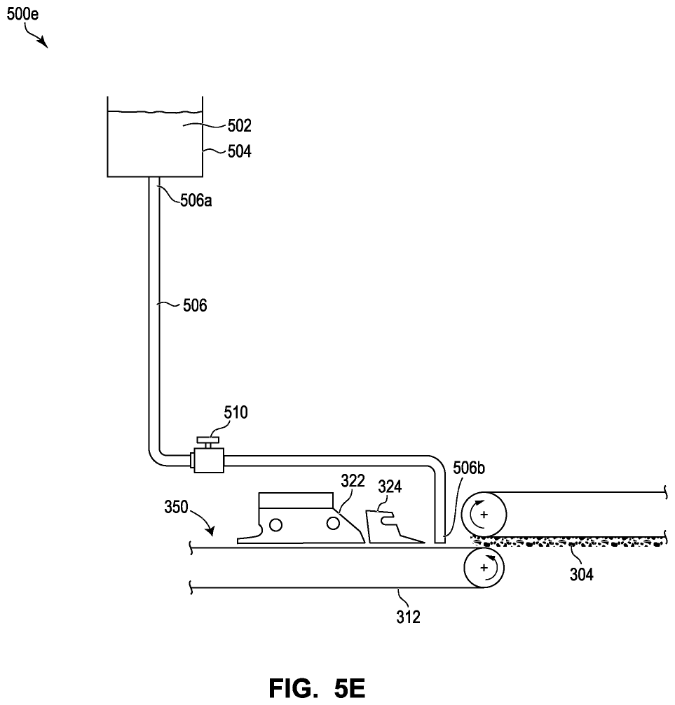

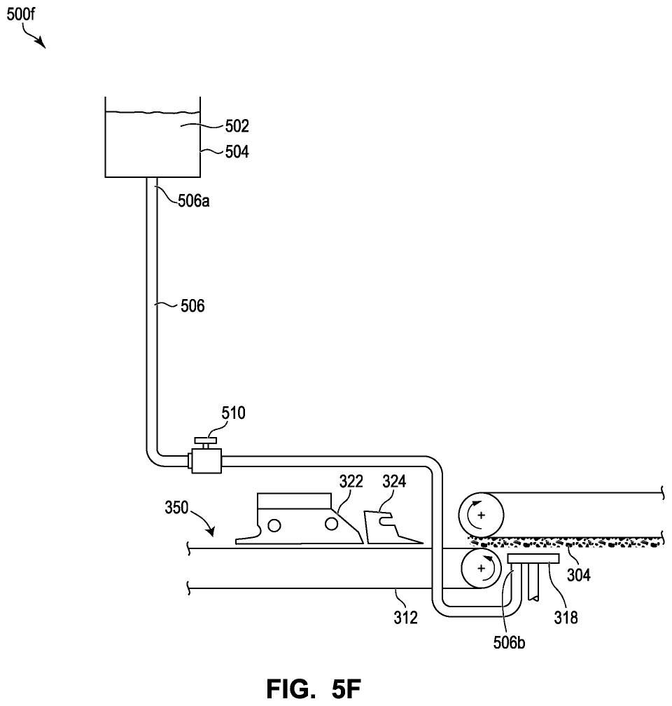

FIGS. 5A-5F show various example modified pre-roll machines 500a-500f in accordance with various embodiments provided herein. The modified pre-roll machines can apply lubricant before or during the stage in which the cannabis product is passed through the pre-roll members 320.

As shown, the modified pre-roll machine 500 may include a reservoir of lubricant fluid 502. The lubricant fluid 502 may comprise, for example, an alcohol-based compound (e.g., 99% ethanol fluid), or any other oil-based compound. The lubricant fluid 502 may be retained, for example, in a reservoir tank 504. A tube network 506 may connect to the tank 504, and may transport the fluid 502 from the tank 504 to the staging area 350.

In at least some embodiments, the tank 504 may be installed in an elevated position such that fluid 502 is simply drawn downwardly, through the tube network 506, via gravitational force.

As further shown, the tube network 506 may extend between a first open end 506a and a second open end 506b. The first tube end 506a may directly or indirectly couple to an exit opening of the tank 504. The second tube end 506b may connect to various components in the staging area 350.

FIG. 5A shows an example modified pre-roll machine 500a, in accordance with some embodiments. In the illustrated embodiment, the second tube end 506b is connected to a modified tongue member 512.

As shown in FIGS. 6A and 6B, the modified tongue member 512 includes a design that is generally analogous to that of the tongue member 322 (FIG. 4A), with the exception that the tongue member 512 is modified to include a conduit 602. Conduit 602 extends from the top tongue surface 402a to the bottom tongue contact surface 402b.

Using this design, the second tube end 506b may couple to an opening 606 on the top surface 402a. Lubricant fluid 502 may accordingly enter through the opening 606, travel through the conduit 602 and exit the from one or more openings 604 positioned on the bottom contact surface 402b. As the lubricant fluid 502 exits from the bottom openings 604, the fluid may contact the cannabis product which is travelling under the bottom surface 402b (i.e., on the conveyor belt 312), and may mix with the cannabis product. In this manner, the cannabis product may be lubricated such as to prevent clumping or clogging of the cannabis as it travels, and is compressed by, the narrow passage of the tongue member 512.

In other embodiments, the conduit opening 606 may not be necessarily positioned on the top tongue surface 402a, but may be located along any other suitable surface (i.e., a side lateral surface of the tongue member 512).

As shown in FIG. 6B, the bottom openings 606 may be preferably positioned near the upstream end 404a of the tongue's bottom surface 402b. This configuration allows the lubricant fluid 502 to be applied immediately as the cannabis product and rolling medium are being conveyed under the tongue member 512, and prior to the cannabis being constricted by the tongue's narrowing passage.

In other embodiments, the bottom openings 606 may also be positioned along any other suitable portion of the bottom contact surface 402b. For example, the openings 606 may be positioned generally centrally between the upstream and downstream ends (FIG. 6C) or generally towards the downstream end 404b (FIG. 6D). In still other embodiments, the openings 606 may be spaced or distributed (i.e., evenly or unevenly), as between the upstream end 404a and the downstream end 404b (FIG. 6E). In still yet other embodiments, some openings may be positioned near the upstream end 404a while other openings may be positioned near the downstream end 404b (FIG. 6F). It will therefore be understood that numerous possibilities and variations exist for the position configuration of the openings 606 along the bottom contact surface 404b. Additionally, while the illustrated embodiments show a plurality of bottom openings 606, in other cases, there may be only a single opening 606 provided on the bottom contact surface 402b and having any desired position configuration.

FIG. 5B shows another example of a modified pre-roll machine 500b, in accordance with some other embodiments. In this embodiment, the second tube end 506b is connected to a modified shoe member 514, rather than a modified tongue member.

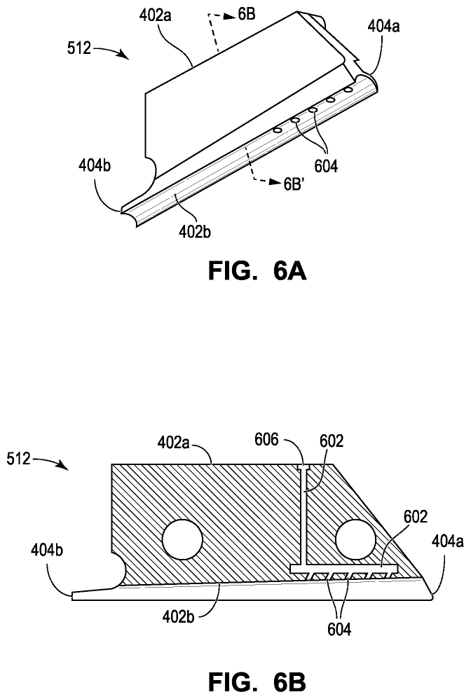

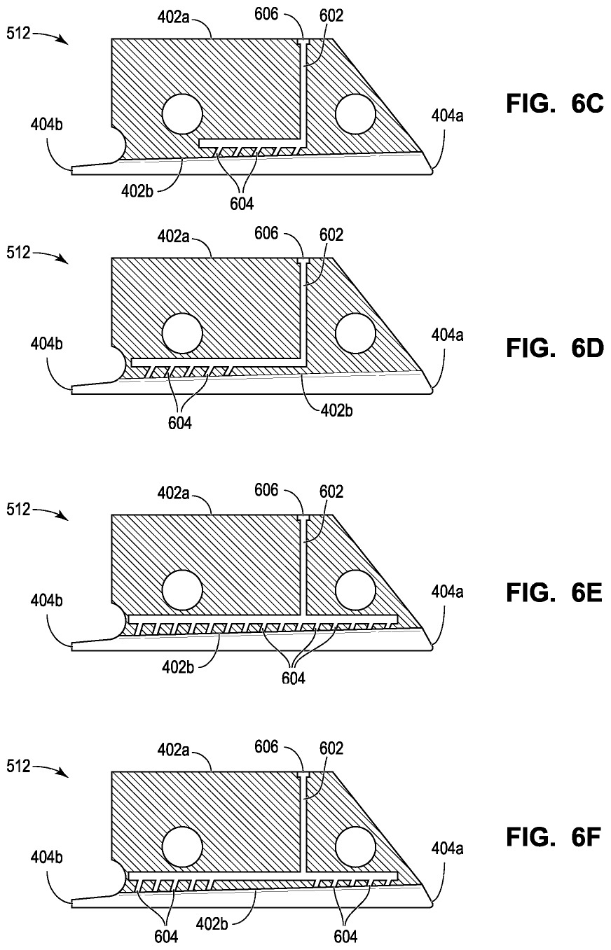

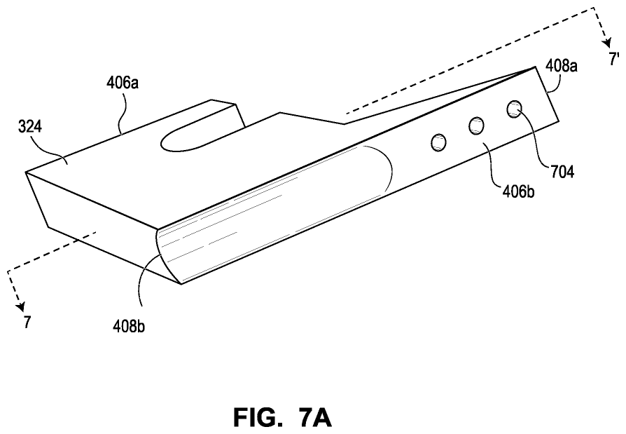

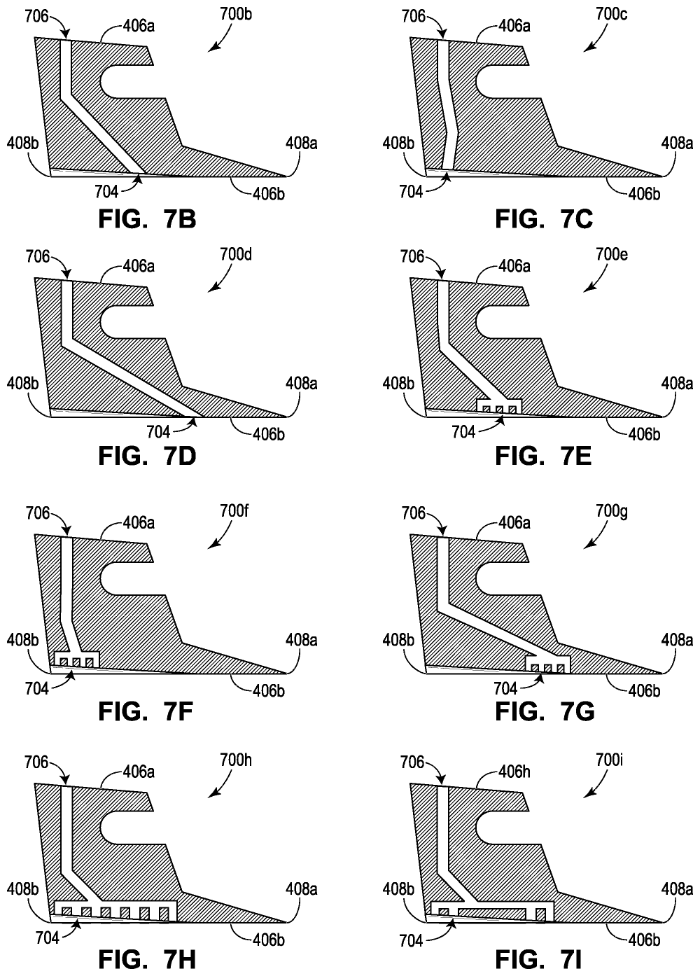

FIGS. 7A-7H illustrate various non-limiting designs and configurations (including 700b-700i) for a modified shoe member 514. As shown, the modified shoe member 514 may have a similar design to the modified tongue member 512 (FIGS. 6A-6E). For example, the modified shoe member 514 may also include a conduit 702 that extends from an opening 706, disposed on the top surface 406a, to one or more openings 704, disposed on the bottom surface 406b. In other cases, the opening 706 may be disposed on any other surface of the shoe member 514 (i.e., a lateral surface).

The second tube end 506b may accordingly couple to the opening 706 (FIG. 5B), such that lubricant 502 enters through the top opening 706 and travels through the conduit 702 to exit from one or more of the bottom openings 704. The lubricant 502 may then mix with the cannabis product being conveyed below the shoe member 514.

Similar to the design of the modified tongue member 512—the bottom openings 704 may be disposed in various position configurations. For example, the bottom openings 704 may be disposed near a downstream end 408b of the bottom surface 406b (FIGS. 7C, 7F), between the upstream and downstream ends (FIGS. 7B, 7E) or near the upstream end 408a (FIGS. 7D, 7G). In some cases, only a single opening 704 may be provided (FIGS. 7B-7D), while in other cases, there may be a plurality of openings 704 (FIGS. 7E-7G). Further, where a plurality of openings 704 are provided, the openings 704 may be distributed (i.e., evenly or unevenly) between the upstream and downstream ends (FIG. 7I), or may be distributed (i.e., evenly or unevenly) along the entire length of the bottom surface (FIG. 7H).

FIG. 5C shows another example of a modified pre-roll machine 500c, in accordance with some other embodiments. In this embodiment, the tube 506 may have more than one second end, whereby a first secondary end 506b1 is connected to a modified tongue member 512 (FIGS. 6A-6E), and second secondary end 506b2 is connected to a modified shoe member 514 (FIGS. 7B-7F). In this configuration, lubricant may be applied both at the shoe and at the tongue stages.

FIGS. 5D and 5E show sill other examples of modified pre-roll machines in accordance with still other embodiments. In these embodiment, the second tube end 506b may not connect to the tongue 322 or shoe 324, but may open over an area located between the two members (FIG. 5D), or in area located before the shoe member 324 (FIG. 5E).

FIG. 5F shows yet another example embodiment whereby the second tube end 506b is connected to the rotating disk 318. For example, the disk 318 may have one or more openings extending therethrough that connect to the second tube end 506b, and which allow lubricant fluid to extrude through the disk 318 and into contact with the cannabis product 304.

In at least one embodiment, the modified pre-roll machines may include a restrictor valve mechanism 510 (FIGS. 5A-5F). The valve mechanism 510 may control the rate of fluid flow through the tube network 506 and can limit the amount of lubricant fluid 502 applied to the cannabis composition. In some cases, the valve mechanism 510 is controlled such that lubricant fluid 502 is delivered in a drip sequence, rather than as a continuous stream. In other words, the valve 510 may ensure that the fluid exiting the modified tongue member 512 (via openings 604) or modified shoe member 514 (via openings 704) is applied in drip form. In some example cases, the valve mechanism 510 can control the drip rate to be in a range between about 47 drops per minutes to about 74 drops per minutes. An appreciated advantage of dripping the lubricant fluid 502 is to compensate for the Venturi effect and to otherwise avoid overwhelming the loose cannabis and rolling medium with lubricant fluid.

In some embodiments, the valve mechanism 510 may be controlled having regard to one or more drip rate adjusting factors. One example drip rate adjusting factor is the machine or rod speed (i.e., speed of the conveyor belt 312). The machine speed can be expressed as the number of joints manufactured per minute (i.e., 1800 joints or rods per minute). The machine speed can also be expressed as the linear joint speed on conveyor belt 312. For instance, where each joint or rod has a desired length of 53 mm (i.e., 0.053 meters), and the production rate is 1800 joints per minute—then the linear joint speed is approximated to 95 meters per minute (i.e., 1800 joints/minute×0.053 meters=95.4 meters/minute).

In at least one embodiment, the valve mechanism 510 is adjusted in increasingly proportionality to the machine or rod speed. For example, the drip rate can be proportionality adjusted to be a pre-defined fraction of the linear rod speed (i.e., 10% to 30% of the linear rod speed).

A further example drip rate adjusting factor is the dryness of the cannabis composition. In particular, some cannabis compositions may be more oily or dryer than other cannabis compositions. This may be dependent, for example, on the particular cannabis strain, or other pre-treatment processes applied to the cannabis composition. In some example cases, the drip rate is reduced for more oily cannabis compositions. In various cases, this is because it may not be desirable to apply more alcohol to an already oily composition as the oil may already act as a surrogate lubricant. Additionally, the addition of alcohol may adversely react with the embedded oil. Conversely, there may be a greater flexibility to increase the drip rate for dryer cannabis compositions.

In at least some embodiments, the drip adjusting factors are determined manually and/or the valve 510 is manually adjusted to control the drip rate. For instance, a user can manually observe the machine speed, and in turn, can manually control the valve 510 to adjust the drip rate. Similarly, a user can manually observe, determine or assess the cannabis composition dryness, and in turn, may manually control the valve 510 to appropriately adjust the drip rate.

In other embodiments, an automated process is used to determine the drip rate adjusting factors as well as to control the valve 510.

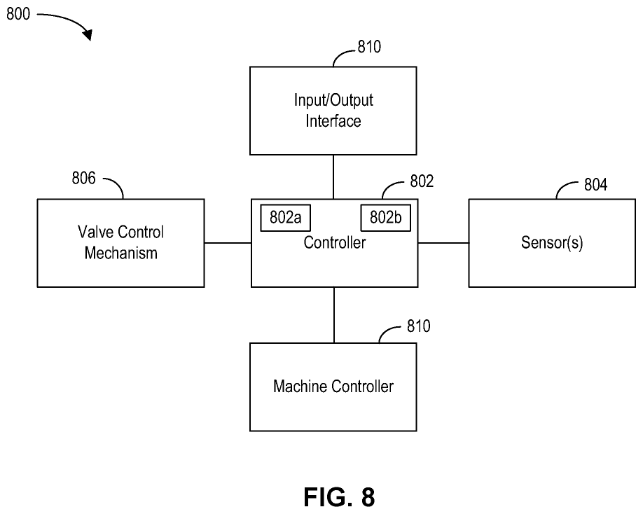

Reference is now made to FIG. 8, which shows a simplified block diagram for an automated drip rate adjusting system 800, in accordance with some embodiments.

System 800 includes a controller 802 in communication (i.e., wired or wireless communication) with one or more sensors 804, a valve control mechanism 806, an input interface 810 and a machine controller 810.

Sensors 804 may be any suitable sensors for monitoring cannabis composition properties. For example, sensors 804 can comprise sensors that can measure (directly or indirectly) a level of dryness or residue of the cannabis composition (i.e., optical or ultrasonic sensors as is known in the art). Sensors 804 may be positioned proximal the conveyor belt 312, and upstream of one or more of the pre-roll members 320, in order to monitor for cannabis composition properties.

Valve control mechanism 806 may be an electro-mechanical mechanism coupled to the valve 510. Valve control mechanism 806 can be used to control the valve 510 such as to adjust the outgoing drip rate.

Input/output (I/O) interface 810 may be any interface for receiving user inputs as well as displaying output data (i.e., buttons, touch display LCD screens). In some embodiments, a user may use the I/O interface 810 to enter a desired drip rate which is then communicated to the controller 802. In other cases, a user may enter other parameters-such as the machine or roll speed or cannabis composition properties-which may also be communicated to the controller 802.

Machine controller 810 may be a machine control mechanism, and may be operable to communicate various machine operating properties (i.e., machine or roll speed) to controller 802.

Controller 802 may receive inputs from one or more of the sensors 804, input interface 810 and machine controller 810, and may use the inputs to control the valve control mechanism 806.

In some example embodiments, controller 802 may receive sensor data from sensors 804, and may analyze the sensor data to determine a dryness factor of the cannabis composition. In turn, the controller 802 may determine a drip rate suitable for the determined dryness. Controller 802 may then transmit control instructions to the valve control mechanism 806 to vary the drip rate.

In other example embodiments, controller 802 can determine a machine operating speed. This can be automatically determined from operating data received from the machine controller 810. Controller 802 can use the machine operating speed to determine an appropriate drip rate, and in turn, can transmit control instructions to the valve control mechanism 806.

In other cases, controller 802 can determine or control the drip rate based on one or more user inputs received via the I/O interface 810.

In various cases, controller 802 may include a processor 802a coupled to a memory 802b. Processor 802a is a computer processor, such as a general purpose microprocessor. In some other cases, processor 802a may be a field programmable gate array, application specific integrated circuit, microcontroller, or other suitable computer processor. Memory 802b may include both volatile and non-volatile memory. Non-volatile memory stores computer programs consisting of computer-executable instructions, which may be loaded into volatile memory for execution by processor 802a as needed. It will be understood by those of skill in the art that references herein to controller 802 as carrying out a function or acting in a particular way imply that processor 802a is executing instructions (e.g., a software program) stored in memory 802b and possibly transmitting or receiving inputs and outputs via one or more interface. Memory 802b may also store data input to, or output from, processor 802a in the course of executing the computer-executable instructions. In various cases, memory 802b may store software for determining appropriate drip rate based on one or more drip rate adjusting factors.

### Other Embodiments

In addition, although described primarily in the context of methods and systems, other implementations are also contemplated, as instructions stored on a non-transitory computer-readable medium, image processing, and/or control features for example.

A number of embodiments of the invention have been described. Nevertheless, it will be understood that various modifications may be made without departing from the spirit and scope of the invention.

Accordingly, other embodiments are within the scope of the appended claims.

Other examples of implementations will become apparent to the reader in view of the teachings of the present description and as such, will not be further described here.

Unless otherwise defined, all technical and scientific terms used herein have the same meaning as commonly understood by a person of ordinary skill in the art to which the present invention pertains.

Note that titles or subtitles may be used throughout the present disclosure for convenience of a reader, but in no way these should limit the scope of the invention. Moreover, certain theories may be proposed and disclosed herein; however, in no way they, whether they are right or wrong, should limit the scope of the invention so long as the invention is practiced according to the present disclosure without regard for any particular theory or scheme of action.

All references cited throughout the specification are hereby incorporated by reference in their entirety for all purposes.

Reference throughout the specification to “some embodiments”, and so forth, means that a particular element (e.g., feature, structure, and/or characteristic) described in connection with the invention is included in at least one embodiment described herein, and may or may not be present in other embodiments. In addition, it is to be understood that the described inventive features may be combined in any suitable manner in the various embodiments.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps.

Unless otherwise defined, all technical and scientific terms used herein have the same meaning as commonly understood by one of ordinary skill in the art to which this invention pertains. In the case of conflict, the present document, including definitions will control.

As used in the present disclosure, the terms “around”, “about” or “approximately” shall generally mean within the error margin generally accepted in the art. Hence, numerical quantities given herein generally include such error margin such that the terms “around”, “about” or “approximately” can be inferred if not expressly stated.

Although various embodiments of the disclosure have been described and illustrated, it will be apparent to those skilled in the art in light of the present description that numerous modifications and variations can be made. The scope of the invention is defined more particularly in the appended claims.

1. A system for alcohol-based lubrication for pre-roll machinery comprising:
a reservoir tank for retaining lubricant fluid;
a tube conduit having a first end fluidically coupled to the reservoir tank and an open second end; and
a modified pre-roll member having a fluid-receiving opening coupled to the second tube end, the modified pre-roll member further comprising a bottom contact surface including one or more fluid exit openings coupled to the fluid-receiving opening.

2. The system of claim 1, wherein the modified pre-roll member comprises one or more of a modified tongue member and a modified shoe member.

3. The system of claim 1, wherein the bottom contact surface, of the modified pre-roll member, has an upstream end and a downstream end, the downstream end being opposed to the upstream end.

4. The system of claim 3, wherein the one or more fluid exit openings are positioned proximal the upstream end.

5. The system of claim 3, wherein the one or more fluid exit openings are positioned proximal the downstream end.

6. The system of claim 3, wherein the one or more fluid exit openings are positioned proximal each of the upstream and the downstream ends.

7. The system of claim 3, wherein the one or more fluid exit openings are positioned between the upstream end and the downstream end.

8. The system of claim 3, wherein the one or more fluid exit openings are distributed between the upstream end and the downstream end, and the distribution is either uniform or non-uniform.

9. The system of claim 1, wherein a valve is positioned along the tube conduit, and is controllable to adjust the drip rate of the lubricant fluid through the modified pre-roll member.

10. The system of claim 9, wherein the drip is adjusted having regarding to one or more drip rate adjusting factors.

11. The system of claim 10, wherein the one or more drip rate adjusting factors comprise one or more of a dryness of a cannabis composition, and a rod manufacturing rate.

12. The system of claim 9, wherein the system further comprises a controller coupled to a valve control mechanism, the valve control mechanism being operable to the control valve to automatically adjust the drip rate, and the controller is operable to transmit control instructions to the valve control mechanism based on the one or more drip rate adjusting factors.

13. The system of claim 12, wherein the system further comprises one or more sensors coupled to the controller, the sensors operable to monitor one or more cannabis composition properties, and the controller is operable to determine the one or more drip rate adjusting factors based on the one or more monitored cannabis composition properties.

14. The system of claim 1, wherein the lubricant fluid is an alcohol-based compound.

15. The system of claim 14, wherein the alcohol-based compound comprises 99% ethanol fluid.

16. A system for forming a cannabis smoking article, the system comprising:
a conveyance system configured to convey a cannabis composition from a repository and deposit the cannabis composition on a rolling medium;
one or more rotatable disks configured to control a dispersion of the cannabis composition on the rolling medium;
one or more rolling members configured to roll the rolling medium around the cannabis composition and form the smoking article, the one or more rolling members including a modified pre-roll member comprising a fluid receiving opening for receiving a lubricant from a reservoir tank and one or more liquid exit openings fluidly coupled to the fluid-receiving opening and configured to deliver the lubricant to the cannabis composition.

17. A system for forming a cannabis smoking article, the system comprising:
a conveyance system configured to convey a cannabis composition from a repository and deposit the cannabis composition on a rolling medium;
one or more modified rotatable disks configured to control a dispersion of the cannabis composition on the rolling medium;
a reservoir tank for retaining lubricant fluid; and
a tube conduit having a first end fluidically coupled to the reservoir tank and an open second end coupled to the modified rotatable disk.

18. A method for alcohol-based lubrication for pre-roll machinery comprising:
determining a drip rate based on one or more drip rate adjusting factors;
adjusting a valve mechanism to apply the drip rate;
applying the alcohol-based lubrication via a modified pre-roll member, wherein the modified pre-roll member has a fluid-receiving opening coupled to a second tube end of a tube conduit, the modified pre-roll member further comprising a bottom contact surface including one or more fluid exit openings coupled to the fluid-receiving opening and used for extruding the alcohol-based lubricant,
wherein the tube conduit has a first end fluidically coupled to a reservoir tank for retaining the lubricant fluid, and
the valve is positioned along the tube conduit, and is controllable to adjust the drip rate of the lubricant fluid through the modified pre-roll member.

19. The method of claim 18, wherein the modified pre-roll member comprises one or more of a modified tongue member and a modified shoe member.

20. The method of claim 18, wherein the one or more drip rate adjusting factors comprise one or more of a dryness of a cannabis composition, and a rod manufacturing rate.
